(19) United States
(12) Patent Application Publication
(10) Pub. No.: US 2008/0088281 A1
(43) Pub. Date: Apr. 17, 2008

(54) System and method for battery charging

(76) Inventors: Christopher R. Paul, Bayport, NY (US); Kevin Cordes, Miller Place, NY (US); Joseph Cabana, Centereach, NY (US)

Correspondence Address: FAY KAPLUN & MARCIN, LLP, 15O BROADWAY, SUITE 702, NEW YORK, NY, 10038, US

(21) Appl. No.: 11/581,970

(22) Filed: Oct. 16, 2006

(51) Int. Cl. H02J 7/04

(52) U.S. Cl. 320/141

(57) ABSTRACT

A battery charging device includes (i) a first circuit receiving a pulse width modulated signal, (ii) a second circuit receiving the pulse width modulated signal, and (iii) a third circuit receiving the pulse width modulated signal. The first circuit generates a first input to set a maximum battery charge current produced by the battery charging device. The second circuit generates a second input to disable the battery charging device based on the pulse width modulated signal. The third circuit generates a third input to select a charging mode of the battery charging device.

### FIELD OF THE INVENTION

The present invention relates generally to a system and method for battery charging. Specifically, the control inputs for battery charging components (e.g., integrated circuit) occupy a single pin on a supervising microprocessor of a portable device.

### BACKGROUND

Portable devices incorporate an integrated circuit (IC) for providing battery charging functions. The IC requires several input signals to provide control for these battery charging functions. The control is often accomplished using a supervising microprocessor (μP). The input signals are sent from the μP through physical contacts called pins. However, because of various design considerations (e.g., size, cost, etc.), the set of pins on the μP may be limited, making each pin a valuable commodity. Thus, the multiple input signals required by the battery charging IC uses multiple pins of the μP, thereby limiting additional functionalities/components in the portable device from using these pins.

### SUMMARY OF THE INVENTION

The present invention relates to a battery charging device. The device may include (i) a first circuit receiving a pulse width modulated signal, (ii) a second circuit receiving the pulse width modulated signal, and (iii) a third circuit receiving the pulse width modulated signal. The first circuit generates a first input to set a maximum battery charge current produced by the battery charging device. The second circuit generates a second input to disable the battery charging device based on the pulse width modulated signal. The third circuit generates a third input to select a charging mode of the battery charging device.

### DESCRIPTION OF THE DRAWINGS

FIG. 1 shows an exemplary system of a battery charger arrangement according to an exemplary embodiment of the present invention.

FIG. 2 shows a schematic diagram of the battery charger arrangement of FIG. 1.

FIG. 3 shows an exemplary method of charging a battery using the battery charger arrangement of FIG. 1.

### DETAILED DESCRIPTION

The present invention may be further understood with reference to the following description and the appended drawings, wherein like elements are referred to with the same reference numerals. The present invention describes a battery charging arrangement where inputs for controlling the battery charger are incorporated to occupy a single pin on a microprocessor (μP). According to the exemplary embodiments of the present invention, the battery charger includes components such as a charge enable/disable component, a charge rate selection component, and a maximum charge current component. The inputs for controlling these battery charger components all come from a single pin of the μP. The battery charging arrangement and the battery charger components in relation to the μP will be discussed in more detail below. The present invention obviates the use of multiple μP pins by using a single μP pin to control multiple functions of the battery charger.

When a lithium ion battery (LIB) is in a low state of charge (a “pre-charge” state), care must be taken to charge the LIB at rate much lower than normal so as not to damage it. The LIB is typically known to be in such a state because it is determined to be below the pre-charge voltage (PCV) specified by the LIB manufacturer. The charge current typically supplied in such a state is called the pre-charge current (PCC). The exact magnitude of PCC is not important; it serves only to slowly charge the LIB until its voltage exceeds the PCV. When this occurs, a much higher constant charge current (typically 10 times PCC) can be applied to speed up the charging of the battery. This current, called the Full Charge Current (FCC), is applied until the LIB reaches the Maximum Charge Voltage (MCV) as specified by its manufacturer. At this time, the battery is subjected to a constant charge voltage of MCV by the charger. During this time, the supplied charge current is slowly falling as the battery continues to charge. Typically, all charging is terminated when the charging current falls below a threshold called the Charge Termination Current (CTC).

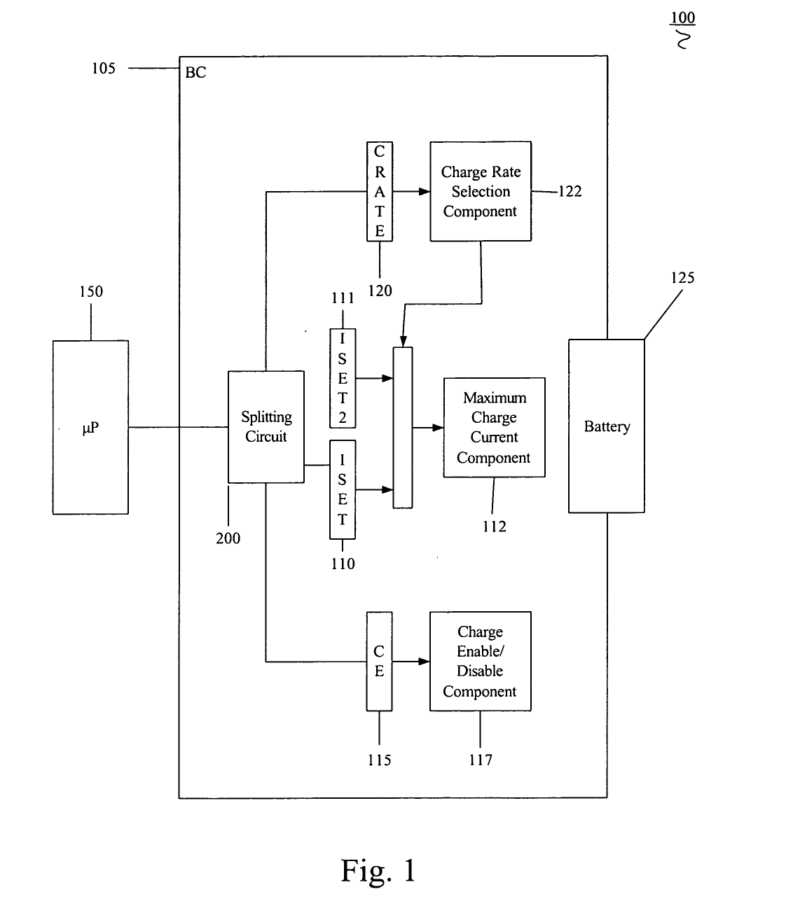

FIG. 1 shows an exemplary system of a battery charger arrangement 100 according to an exemplary embodiment of the present invention. The battery charger arrangement 100 includes a battery charger (BC) 105 that is connected to a μP 150 to charge a battery 125. The BC 105 includes a splitting circuit 200, a maximum charge current component 112 receiving either current setter input (ISET) 110 or ISET2 111, a charge enable/disable component 117 receiving a charger enable input (CE) 115, and a charge rate selection component 122 receiving a charge rate determiner input (CRATE) 120. The splitting circuit 200 receives a signal from the μP 150 and sends a corresponding signal to each component 120, 110, 111 and 115. The ISET input 110, the CE input 115, and the CRATE input 120 are generated by a splitting circuit 200 based on one signal of the μP 150. Each of the components and inputs will be described in greater detail below.

The charge rate selection component 122 selects the source (ISET 110 or ISET2 111) which sets the charge current provided by the Maximum Charge Current Component 112 in the BC 105. As described above, when an LIB is in a very low state of charge, it can be damaged if charged at the FCC rate. To prevent this damage, the uP 150 will monitor the battery voltage. If the voltage is under the PCV, the uP 150 will control the CRATE component 120 to cause the charge current produced by the Maximum Charge Current Component 112 to be selected by ISET2 111, yielding the PCC. When the LIB voltage exceeds the PCV, the uP 150 will control the CRATE component 120 to cause the charge current produced by the Maximum Charge Current Component 112 to be selected by ISET 110, yielding the FCC.

The ISET input 110 and ISET2 input 111 are small direct currents (DC) that may be amplified by a constant factor by the maximum charge current component 112 to provide the desired battery maximum charge current. The level of the ISET2 input 111 is typically fixed by the selection of a value for a resistor that provides a PCC that is safe for the battery being charged. The level of the ISET input 110 is controlled by the uP 150 through splitting circuit 200. These arrangements allow different maximum charging currents to be set to accommodate different LIBs with different FCCs and in accordance with the state of charge of the LIB.

The charge enable/disable component 117 is a component of the BC 105 that controls the activation/deactivation of the BC 105. The CE input 115 controls the activation/deactivation. Those skilled in the art will understand the importance of having the charge enable/disable component 117. For example, an improper activation of the BC 105 when a battery is already fully charged or overheated may create excessive heat that results in damage and/or a decrease in the life of the battery. A premature deactivation of the BC 105 results in a battery that is not fully charged. A delayed deactivation of the BC 105 may also result in excessive heat that damages and/or decreases the life of the battery. Additionally, deactivation is different from leaving the charger activated and configuring the ISET component 110 current to 0. In the latter case, imperfections in typical charger ICs can cause a small current to flow which can still damage the battery, even when the “programmed” charge current is zero. Only in the former case is the residual charge current vanishingly small, eliminating the possibility of battery damage and highlighting the importance of the CE 115 feature.

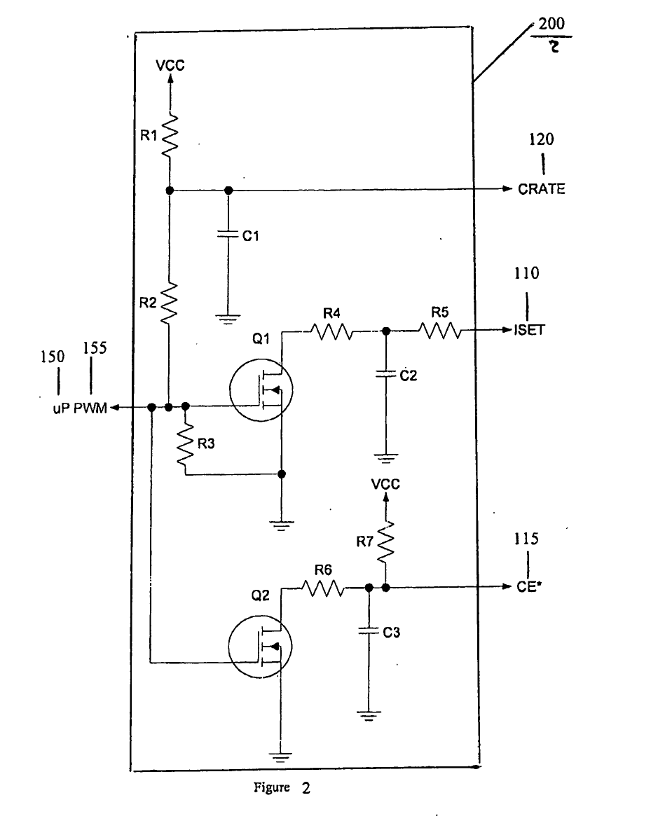

FIG. 2 shows a schematic diagram of the splitting circuit 200 of FIG. 1. FIG. 2 illustrates the individual electronic circuits that comprise the splitting circuit 200 that are used to generate the ISET input 110, the CE input 115, and the CRATE input 120. The circuit for generating the ISET2 input 111 is not shown, but the ISET 2 input 111 may also be provided to the Maximum Charge Current Component 112 based on the current through a fixed resistor. According to the present invention, the arrangement and the specifications of the electronic circuits allow the BC 105 to receive a single signal from a single uP pin and maintain the effective battery charging capabilities as if each component of the BC 105 occupied a respective μP 150 pin. As will be apparent to those skilled in the art, each of the circuits used to generate the inputs 110, 115 and 120 are RC circuits.

As shown in FIG. 2, the output of the μP 150 pin is a pulse width modulated (PWM) signal 155. Those skilled in the art will understand that a typical μP can output a PWM signal at a predetermined frequency. The frequency of the PWM signal may remain constant, but the duty cycle may vary. For example, a 50% duty cycle may indicate that during a frequency cycle the PWM signal 155 may be high for half the time of the cycle and low for the remainder of the cycle (although not necessarily a continuous period of time in the high or low state). As will be described below, the characteristics of the PWM signal 155 may be used in conjunction with the circuitry of the splitting circuit 200 to control the operation of the BC 105. Those skilled in the art will also understand that PWM signal 155 may not necessarily be generated by the μP, but may just be controlled by the μP.

The CRATE circuit includes a grounded capacitor C1, a resistor R1, and a resistor R2. One side of the resistor R1 is connected to a logic power supply (VCC). The other side of the resistor R1 is connected to one side of the resistor R2 and to the ungrounded side of C1. The other side of the resistor R2 receives the PWM signal 155 that is also used to generate the ISET input 110 and the CE input 115 (described in greater detail below). The CRATE input 120 is the averaged voltage across C1. As discussed above, the CRATE input 120 is a digital signal (e.g., one which has only two values: above or below a threshold) that is provided to the charge rate selection component 122 that determines the maximum charge current (PCC or FCC). The CRATE input 120 makes the charge rate determination using the same signal used to generate the ISET input 110 and the CE input 115 (i.e., the PWM signal 155).

According to the exemplary embodiments of the present invention, through selection of the values of R1 and R2 and using C1 to keep ripple on the CRATE input 120 low, the PWM signal 155 duty cycle range may be set to switch between selection of maximum charge current setting components ISET 110 and ISET2 111. In addition, this threshold may be outside the duty cycle range that is used to provide the fine control of the FCC via the ISET 110 input. For example, it may be possible to set the threshold of the PWM signal for the CRATE input at 40% duty cycle (e.g., below 40% duty cycle, the ISET2 input 111 is selected and the PCC is provided to the battery based on the ISET2 input 111; above 40% duty cycle, the ISET input 110 is selected and the FCC is controlled using the PWM signal 155). As will be described in greater detail below, the PWM signal 155 duty cycle from 40% to 100% (in this example) may be used to control the FCC. Thus, the duty cycle used to generate the selection based on the CRATE 120 input may be outside the range used for control of the FCC by the ISET input 110. In addition, any value below the threshold duty cycle will also be outside the range used for control of the FCC by the ISET input 110. Those skilled in the art will understand that the selection of 40% duty cycle in this example is only exemplary and that any non-zero duty cycle may be selected for use as the threshold for the CRATE input 120.

The ISET circuit includes a grounded source N-channel field effect transistor (FET) Q1. The FET Q1 also receives the PWM signal 155 from the μP 150. The drain of the FET Q1 is connected to a resistor R4. The other side of the resistor R4 is connected to a grounded capacitor C2 and a resistor R5. The other side of the resistor R5 is the ISET input 110. Typically, the ISET input 110 appears as a fixed voltage source to R5. Currents flow through Q1, R4, C2 and R5. The current flowing through R5 flows into ISET. As described above, the ISET input 110 is a small DC current that may be amplified by the maximum charge current component 112 using a constant factor to provide the desired battery maximum charge current. In the exemplary embodiment, the current of the ISET input 110 is programmable using the PWM signal 155. The single pin of the μP 150 that generates the PWM signal 155 drives the gate of the FET Q1. When the PWM signal 155 is a logic high, FET Q1 is on and the Q1 side of R4 is grounded. When the PWM signal 155 is low, the FET is off and the Q1 side of R4 floats. If C2 did not exist, when Q1 was on, it would draw a current from ISET determined by the voltage at ISET divided by the sum of the values of the resistances of R4 and R5. Also if C2 did not exist, no current would flow through Q1, R4, R5 and ISET when Q1 was off. The presence of capacitor C2 serves to force a substantially constant voltage across the junction of R4, R5 and C2. This serves to draw a constant current from ISET through R5, which is the average of the current flowing through R4 and Q1. This average is controlled by the duty cycle of the PWM signal 155.

Thus, based on the predetermined specifications for the FET Q1, the resistor R4, the capacitor C2, and the resistor R5, the PWM signal 155 is used to generate a controlled DC current source (ISET 110) that may set the maximum battery charge current produced by the charger IC. Accordingly, as the duty cycle of the PWM signal 155 is altered, the ISET 110 current changes, and thereby the maximum battery current may be altered. As described above, the range of duty cycles of the PWM signal 155 that alters the maximum battery current via the ISET input 110 may not include the PWM signal 155 threshold value for the CRATE input 120. Those skilled in the art will also understand that by selecting the appropriate values for the resistors and capacitors in the RC circuit and the range of the duty cycle for the PWM signal 155, fine control may be exerted over the maximum battery current by fine control of the ISET input 100 current. Those skilled in the art will also understand that the RC circuit is acting as a digital to analog (D/A) converter by receiving the PWM signal 155 and outputting a small DC current.

In contrast to the range of signals described above for control of the ISET 110 input, when the modulation signal from the PWM 155 is constantly zero, the FET Q1 is opened. This will nominally set the charge current to zero. However, those skilled in the art will also understand that the BC 105 is still active and that results in an objectionable leakage current flowing through the battery. This causes damage and/or a decrease in the life of the battery if continuous over a long period of time. Control of this leakage current will be discussed in greater detail below.

The CE circuit includes a grounded N-channel FET Q2. The FET Q2 also receives the PWM signal 155. The drain of the FET Q2 is connected to a resistor R6. The other side of the resistor R6 is connected to a grounded capacitor C3 and a resistor R7. The other side of the resistor R7 is connected to a logic power supply (VCC). The circuit generating the CE input 115 connects to the same single pin of the μP 150 that generates the PWM signal 155 as the circuit generating the ISET signal 110. When the PWM signal 155 is high, FET Q2 is on and the Q2 side of R6 is grounded. When the PWM signal 155 is low, the FET is off and the Q2 side of R6 floats. If C3 did not exist, when Q2 was on, it would draw a current from VCC determined by the voltage VCC divided by the sum of the values of the resistances of R6 and R7. Also if C3 did not exist, no current would flow through Q2, R6, and R7 when Q2 was off. The presence of capacitor C3 serves to force a substantially constant voltage across the junction of R6, R7 and C3. This voltage is set by the duty cycle of the PWM signal 155. Typically, the value of R6 is selected to be much smaller than R7 so that even a very small duty cycle (a very short “on” time for Q2) produces a very low voltage across C3 and therefore at CE 115. As long as Q2 is on periodically for even the shortest period of time, the average voltage at CE is low enough to be interpreted by the BC 105 to be a logic level “low” at this digital input, and the charging function is kept on. It is only when the PWM 155 is uniformly low that FET Q2 is held off, and the large resistor R7 is able to charge C3 up to VCC, where BC 105 interprets a logic “high” level and the charging function is disabled.

It should be noted that the above described battery charging arrangement is exemplary only. Those skilled in the art will understand that the splitting circuit 200 may include different specifications for the electronic circuits. In addition, the splitting circuit 200 may include further circuit components that may further control or decrease ripple effects. The battery charging arrangement 100 may also include further components with corresponding circuitry in the splitting circuit 200 to assist in proper battery charging. However, it should be further noted that the values of the resistors and capacitors described above may be selected so that the voltage across the capacitors have a near zero ripple across them for any PWM signal 155. In addition, a battery charging IC may include various additional components to carry out the functions associated with battery charging.

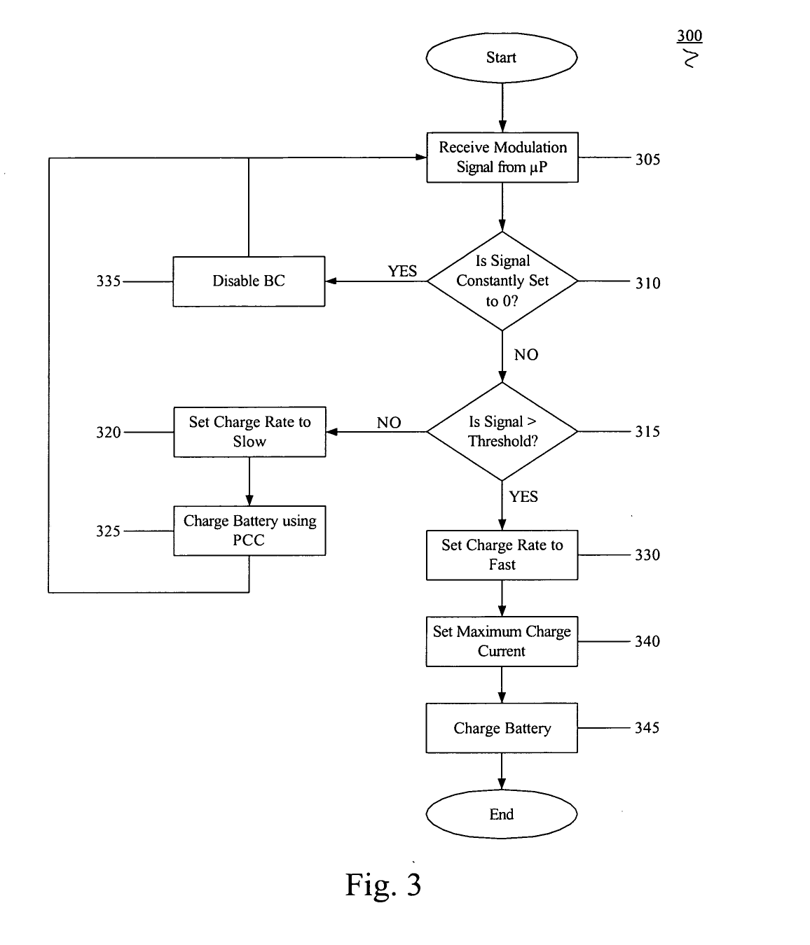

FIG. 3 shows an exemplary method 300 of charging the battery 125 using the battery charger arrangement 100 of FIG. 1. The method 300 will be described with reference to the components 112, 117, 122 described above in FIG. 1 with the corresponding generated inputs 110, 111, 115, 120 for each circuit of the splitting circuit 200 described above in FIG. 2.

In step 305, the PWM signal 155 of the μP 150 is received. The state of PWM signal 155 is then determined in steps 310 and 315. Initially, in step 310 it is determined whether the PWM signal is set constantly to zero. As discussed above, when the PWM signal 155 is constantly set to zero, the FETs Q1 and Q2 are opened, thereby effectively disabling the BC 105 by generating the CE input 115. Thus, if step 310 determines that the PWM signal 155 is constantly set to zero, the method 300 proceeds to step 335 where the BC 105 is disabled (i.e., the CE input 115 is generated). The method 300 then loops back and continues to receive the PWM signal 155 and determine the state of the PWM signal 155. Those skilled in the art will understand that in this exemplary embodiment, the steps 310 and 335 are carried out in the CE circuit portion of the splitting circuit 200. Moreover, the generated CE input 115 will disable the BC 105. Thus, if the CE input 115 is not generated, the BC 105 will be in the on state.

If the step 310 determines that the PWM signal 155 is not constantly zero, the method 300 proceeds to step 315 where it is determined if the duty cycle of the PWM signal is greater than a predetermined threshold that is based on the PCV of the LIB that is to be charged. As described above, the CRATE circuit of the splitting circuit 200 will generate the CRATE input 120 that is used to select the ISET input 110 or the ISET2 input 111. If the PWM signal 155 duty cycle is less than the threshold, the method continues to step 320 where the slow charge rate is set. The battery is then charged using the PCC that is based on the ISET2 input 111. The battery will continue to be charged using the ISET2 input 111 until the battery voltage exceeds the PCV.

In terms of the method 300, the method will constantly loop back to step 305 to receive and check the PWM signal 155. If the PWM signal 155 duty cycle is initially above the threshold in step 315 or if it goes above the threshold based on the slow charging, the method will continue to step 330 where the fast charge rate is set. The maximum charge current is then set in step 340 based on the ISET input 110. As described above, the maximum battery charge current is settable based on the duty cycle of the PWM signal 155 (e.g., as the PWM duty cycle is altered within the range of fast charge rate, the maximum battery charge current will vary as the ISET input 110 varies). The battery is then charged in step 345 until the charging current falls below the CTC. The battery is then considered fully charged and the charging is terminated. Those skilled in the art will also understand that while not shown in the method 300, during the fast charge, the PWM signal 155 will constantly be checked to determine if the maximum charge current should be altered based on the PWM signal 155 as altered by the ISET circuit to produce the ISET 110 input.

In the exemplary embodiments described above, the splitting circuit 200 is used to generate inputs for a battery charger IC. However, the present invention is not limited to applications involving battery charging ICs, but may be used for any application for which a PWM signal is used to control the application. For example, control of cold cathode fluorescent lamps (CCFLs) may be accomplished using a PWM signal. In the CCFLs example, a first output generated from the PWM signal may be used to control the on/off function while a second signal generated from the PWM signal may be used to control the brightness. In another example, a digital audio component may be controlled using the PWM signal. For example, a first output generated from the PWM signal may be used to control the on/off function while a second signal generated from the PWM signal may be used to control the volume or any other characteristic of the audio file being played. Thus, the PWM control may be useful in many applications.

The following table provides exemplary values for the components shown in FIG. 2 for two scenarios (Scenario 1 and Scenario 2). Those skilled in the art will understand that the values provided below are only exemplary and that other values may be used.

| Component | Scenario 1 Value | Scenario 2 Value |
|---|---|---|
| R1 | 909K; 909K; 18.2K | 909K; 909K; 18.2K |
| | (3 resistors in series) | (3 resistors in series) |
| R2 | 100K | 100K |
| R3 | 100K | 100K |
| R4 | 20K | 18.2K |
| R5 | 5K | 4.64K |
| R6 | 100 | 100 |
| R7 | 200K | 200K |
| C1, C2, C3 | 0.1 | 0.1 |
| VCC | 3.3 | 3.3 |

### The resistor values are in ohms, the capacitance values are in microFarads and the voltage values are in volts.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A battery charging device, comprising:
a first circuit receiving a pulse width modulated signal, the first circuit generating a first input to set a maximum battery charge current produced by the battery charging device;
a second circuit receiving the pulse width modulated signal, the second circuit generating a second input to disable the battery charging device based on the pulse width modulated signal; and
a third circuit receiving the pulse width modulated signal, the third circuit generating a third input to select a charging mode of the battery charging device.

2. The battery charging device of claim 1, wherein the first, second, and third circuits receive the pulse width modulated signal from a single pin on a microprocessor.

3. The battery charging device of claim 1, wherein the third circuit generates the third input having a voltage, wherein, when the voltage is above a threshold a first charging mode is selected and when the voltage is below the threshold a second charging mode is selected.

4. The battery charging device of claim 3, wherein the first charging mode is a fast charging mode and the first input is selected to control the maximum battery charge current.

5. The battery charging device of claim 3, wherein the second charging mode is a slow charging mode and a further input is selected to control the maximum battery charge current.

6. The battery charging device of claim 3, wherein a duty cycle range of the pulse width modulated signal used to generate the first input does not include a duty cycle of the pulse width modulated signal corresponding to the threshold.

7. The battery charging device of claim 1, wherein the second circuit generates the second input when the pulse width modulated signal is constantly set to zero.

8. The battery charging device of claim 1, wherein at least one of the first, second and third circuits is an RC circuit.

9. A method, comprising:
receiving a pulse width modulated signal from a microprocessor;
selecting a charging mode of a battery charging device based on the pulse width modulated signal.
setting a maximum battery charge current produced by the battery charging device based on the pulse width modulated signal; and
enabling the battery charging device based on the pulse width modulated signal.

10. The method of claim 9, further comprising:
disabling the battery charging device based on the pulse width modulated signal.

11. The method of claim 9, wherein the charging mode is one of a fast charge mode and a slow charge mode.

12. The method of claim 11, wherein, when the fast charge mode is selected, the setting comprises:
generating, by a first circuit, a first input from the pulse width modulated signal, the first input being a direct current.

13. The method of claim 10, wherein the disabling comprises:
generating, by a second circuit, a second input from the pulse width modulated signal.

14. The method of claim 9, wherein the selecting comprises:
generating, by a third circuit, a third input from the pulse width modulated signal, wherein if the third input is greater than a predetermined threshold, a fast charge mode is selected and if the third input is less than the predetermined threshold, a slow charge mode is selected.

15. The method of claim 10, wherein the disabling is performed when the pulse width modulated signal is constantly set to zero.

16. A battery charging device, comprising:
a first means for receiving a pulse width modulated signal, the first means generating a first input to set a maximum battery charge current produced by the battery charging device;
a second means for receiving the pulse width modulated signal, the second means generating a second input to disable the battery charging device based on the pulse width modulated signal; and
a third means for receiving the pulse width modulated signal, the third means generating a third input to select a charging mode of the battery charging device.

17. The battery charging device of claim 16, wherein the third means generates the third input having a voltage, wherein, when the voltage is above a threshold a first charging mode is selected and when the voltage is below the threshold a second charging mode is selected.

18. The battery charging device of claim 17, wherein the first charging mode is a fast charge mode and the second charging mode is a slow charge mode.

19. The battery charging device of claim 16, wherein the first means generates the first input based on a duty cycle of the pulse width modulated signal.

20. The battery charging device of claim 16, wherein the second means generates the second input when the pulse width modulated signal is constantly set to zero.

21. The battery charging device of claim 16, wherein the first, second, and third means receive the pulse width modulated signal from a single pin on a microprocessor.

22. A device, comprising:
a pulse width modulator receiving means for receiving a pulse width modulated signal; and
a splitting means to split the pulse width modulated signal into at least two outputs, each of the two outputs being altered versions of the pulse width modulated signal, wherein the two outputs are used to control different functionalities of a single further device.
